(19) United States
(12) Patent Application Publication
(10) Pub. No.: US 2013/0229336 A1
(43) Pub. Date: Sep. 5, 2013

(54) STEREOSCOPIC IMAGE DISPLAY DEVICE, STEREOSCOPIC IMAGE DISPLAY METHOD, AND CONTROL DEVICE

(71) Applicants: Kenichi SHIMOYAMA, Tokyo (JP); Ryusuke HIRAI, Tokyo (JP); Masako KASHIWAGI, Yokohama-shi (JP); Takeshi MITA, Yokohama-shi (JP)

(72) Inventors: Kenichi SHIMOYAMA, Tokyo (JP); Ryusuke HIRAI, Tokyo (JP); Masako KASHIWAGI, Yokohama-shi (JP); Takeshi MITA, Yokohama-shi (JP)

(21) Appl. No.: 13/724,611

(22) Filed: Dec. 21, 2012

(30) Foreign Application Priority Data
Mar. 2, 2012 (JP) 2012-047195

(51) Int. Cl. G06F 3/00

(52) U.S. Cl. CPC G06F 3/005
USPC 345/156

(57) ABSTRACT

According to one embodiment, a stereoscopic image display device includes a display element in which a plurality of pixels are arranged in a matrix topology, an optical element coupled to the display element, the optical element having variable optical characteristics. The device also includes an acquirer, calculator, and controller. The acquirer is configured to acquire person's information including a position of each of at least one person viewing a stereoscopic image. The calculator is configured to calculate, based on the person's information, a weight representing a quality of stereoscopic viewing for each person. The controller is configured to select optical characteristic parameters corresponding to the weight, and control the optical characteristics of the optical element based on the optical characteristic parameters.

### CROSS-REFERENCE TO RELATED APPLICATIONS

This application is based upon and claims the benefit of priority from Japanese Patent Application No. 2012-047195, filed Mar. 2, 2012, the entire contents of which are incorporated herein by reference.

### FIELD

Embodiments described herein relate generally to stereoscopic image display.

### BACKGROUND

A stereoscopic image display device for which the user does not use dedicated glasses displays a plurality of images for different viewpoints, and uses an optical element to control light rays. The controlled light rays are guided to both eyes of a viewer, and he/she can recognize a stereoscopic image as long as his/her observation position falls within an appropriate range (to be referred to as a “viewing range” hereinafter). It may be difficult to view a satisfactory stereoscopic image depending on the relative positional relationship between the viewer and the stereoscopic image display device. Furthermore, even if the viewer is within the viewing range at first, he/she may move outside this range. It is, therefore, preferable to change the mode of stereoscopic image display according to the position of the viewer so as to allow stereoscopy.

There is well known a technique of using a liquid crystal optical element or birefringent element as the above optical element.

### BRIEF DESCRIPTION OF THE DRAWINGS

FIG. 1 is a view showing a stereoscopic image display device according to an embodiment;

FIG. 2 is a view showing a display;

FIG. 3 is a view showing an optical element;

FIG. 4 is a view showing an example of a change in refractive index of the optical element and the alignment state of liquid crystal molecules;

FIG. 5 is a front view showing the display;

FIG. 6 is a block diagram showing a calculator and a controller;

FIG. 7 is a block diagram showing details of a person's information acquirer;

FIG. 8 is a block diagram showing details of the calculator;

FIG. 9 is a view showing the number of parallaxes, the resolution of one parallax image, and a change in viewing range with a change in lens pitch;

FIG. 10 is a view showing a case in which a liquid crystal barrier is applied instead of a birefringent element;

FIG. 11 is a view for explaining a weight based on an optical path length difference;

FIG. 12 is a view for explaining calculation of a weight based on the area of a stereoscopic enable region;

FIG. 13 is a view for explaining calculation of a weight based on a light ray density;

FIG. 14 is a view showing an example of a map obtained by arranging weight values in a real space coordinate system;

FIG. 15 is a block diagram showing details of an image output device;

FIG. 16 is a view for explaining display parameters to be controlled for a viewing range;

FIG. 17 is a view for explaining the display parameters to be controlled for the viewing range;

FIG. 18 is a view for explaining a neighboring viewing range;

FIG. 19 is a view for explaining a control operation according to the arrangement of pixels to be displayed;

FIG. 20 is a view for explaining an operation of controlling a viewing range by moving, rotating, or deforming the display;

FIG. 21 is a view showing light densities when the numbers of parallaxes are different; and

FIG. 22 is a view showing a case in which the number of parallaxes is switched in a software manner.

### DETAILED DESCRIPTION

In general, according to one embodiment, a stereoscopic image display device includes a display element in which a plurality of pixels are arranged in a matrix topology, an optical element coupled to the display element, the optical element having variable optical characteristics. The device also includes an acquirer, calculator, and controller. The acquirer is configured to acquire person's information including a position of each of at least one person viewing a stereoscopic image. The calculator is configured to calculate, based on the person's information, a weight representing a quality of stereoscopic viewing for each person. The controller is configured to select optical characteristic parameters corresponding to the weight, and control the optical characteristics of the optical element based on the optical characteristic parameters.

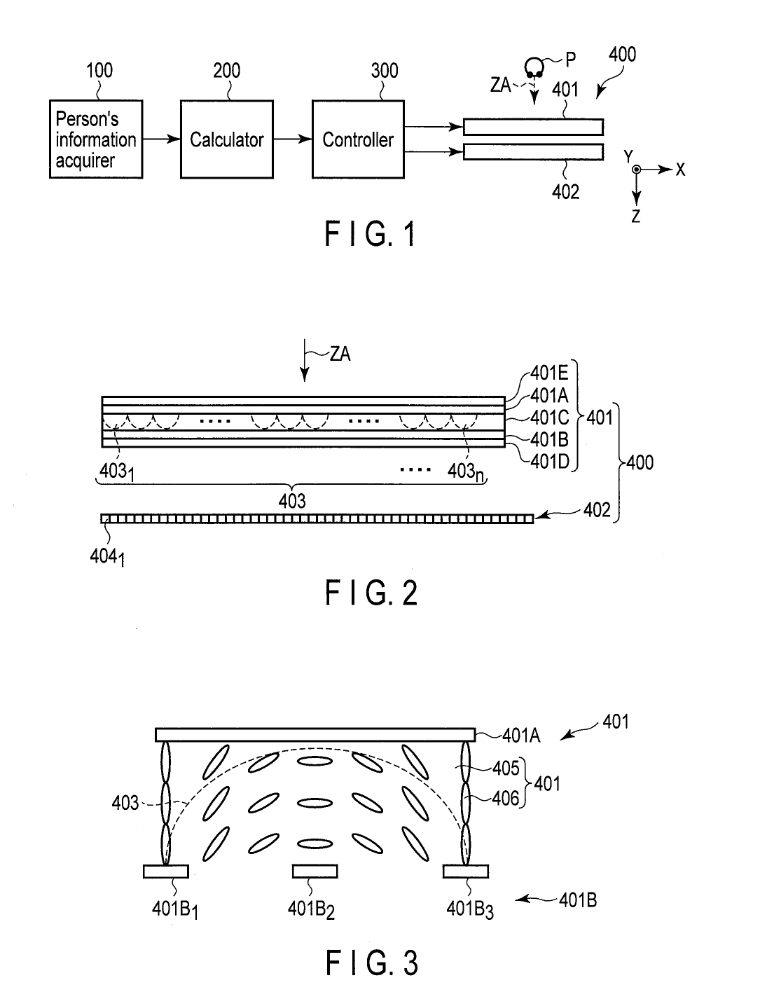

An embodiment will be described below with reference to the accompanying drawings. As shown in FIG. 1, a stereoscopic image display device according to the embodiment includes a person's information acquirer 100, a calculator 200, a controller 300, and a display 400. This device allows a plurality of viewers to view a good quality stereoscopic video at the same time. The device controls display of a stereoscopic image by evaluating the resolution of the stereoscopic image and crosstalk when a birefringent element is used in addition to changing the mode of stereoscopic image display according to the positions of viewers.

The acquirer 100, the calculator 200, and the controller 300 can be realized by one or more central processing unit (CPU) and memory used in the CPU.

A viewer (person) P observes a stereoscopic image and the like displayed on the display 400 by observing a display element 402 through an optical element 401 (see the direction of an arrow ZA in FIG. 1). The display element 402, for example, displays parallax images observed as a stereoscopic image. The display element 402 has a display surface in which a plurality of pixels are arranged in the first and second directions in a matrix topology. The first direction is, for example, the row direction (the X-axis direction (horizontal direction) in FIG. 1), and the second direction is a direction perpendicular to the first direction, and is, for example, the column direction (the Y-axis direction (vertical direction) in FIG. 1).

The person's information acquirer 100 detects the position of the viewer P. This embodiment can be applied when there are a plurality of target viewers, and thus the person's information acquirer 100 detects the position of each person. The person's information acquirer 100 outputs person's information indicating the detected position of each person. The person's information acquirer 100 may cause a detector such as a camera to detect the position of a person, and then obtain the relative position coordinates (to be referred to as “position coordinates (X_{P}, Y_{P})” hereinafter) of the viewer, the relative position is defined as the position of the stereoscopic image display device, based on the detection result. Based on the person's information including the position of each person which has been acquired by the person's information acquirer 100, the calculator 200 calculates a weight representing the quality of stereoscopic viewing for each person. The controller 300 selects display parameters with which the total of the weights of the respective persons that have been calculated by the calculator 200 becomes largest, and outputs a multi-view image (that is, parallax images) according to the selected display parameters. The display 400 displays the multi-view image output from the controller 300.

The display 400 is a display device for displaying a stereoscopic image or plan-view image. FIG. 2 is a schematic view showing the schematic arrangement of the display 400. The optical element 401 is a birefringent element, the refractive index distribution of which changes depending on the applied voltage. Light rays diverge from the display element 402 toward the optical element 401 side, pass through the optical element 401, and exit the optical element 401 in a direction according to the refractive index distribution of the optical element 401. The optical element 401 need only be an element, the refractive index distribution of which changes depending on the applied voltage. As the optical element 401, a liquid crystal element in which liquid crystal molecules are distributed between a pair of substrates is used. Note that a case in which a liquid crystal element is used as the optical element 401 will be described as an example in this embodiment. The optical element 401, however, need only be an element, the refractive index distribution of which changes depending on the applied voltage, and is not limited to a liquid crystal element. For example, a liquid lens which is formed by two kinds of liquid including an aqueous solution and oil, a water lens which uses the surface tension of water, or the like may be used as the optical element 401. The optical element 401 has an arrangement in which a liquid crystal layer 401C is arranged between a pair of substrates 401E and 401D. An electrode 401A is arranged in the substrate 401E. An electrode 401B is arranged in the substrate 401D. Note that in this embodiment, a case wherein the optical element 401 has an arrangement in which electrodes (the electrodes 401A and 401B) are respectively arranged in the substrates 401E and 401D will be described. The optical element 401, however, need only have an arrangement in which it is possible to apply a voltage to the liquid crystal layer 401C, and the present embodiment is not limited to this. The optical element 401 may have, for example, an arrangement in which an electrode is arranged in one of the substrates 401D and 401E.

FIG. 3 is a schematic enlarged view showing a portion of the optical element 401. As shown in FIG. 3, liquid crystal molecules 406 are distributed in a dispersion medium 405 in the liquid crystal layer 401C. A liquid crystal material which is aligned according to the applied voltage is used for the liquid crystal molecules 406. The liquid crystal material need only have the above characteristics, and a nematic liquid crystal material in which the alignment direction changes depending on the applied voltage can be used. As is well known, the liquid crystal material has a long, narrow shape, and has the anisotropy of the refractive index in the longitudinal direction of the molecule. The strength of the applied voltage and a voltage application time for changing the alignment of the liquid crystal molecules 406 are different depending on the type of liquid crystal molecules 406 and the arrangement of the optical element 401 (that is, the shape and arrangement of the electrodes 401A and 401B). A voltage, therefore, is applied to the electrodes 401A and 401B (for example, electrodes 401B₁ to 401B₃) so as to form an electric field having a specific shape at a position, in the liquid crystal layer 401C, which corresponds to each element pixel of the display element 402. Then, the liquid crystal molecules 406 are aligned along the electric field in the liquid crystal layer 401C, and thus the optical element 401 has a refractive index distribution according to the applied voltage. This is because the liquid crystal molecules 406 have refractive index anisotropy according to a polarization state. This is because when the alignment of the liquid crystal molecules 406 changes due to application of a voltage, the refractive index changes in an arbitrary polarization state. For example, the electrodes 401A and 401B are arranged in advance so as to form a different electric field at each position corresponding to each element pixel of the display element 402. Then, a voltage is applied to the electrodes 401B and 401A so as to form an electric field having the shape of a lens 403 in a region, in the liquid crystal layer 401C, which corresponds to each element pixel. The liquid crystal molecules 406 in the liquid crystal layer 401C are then aligned along the electric field formed according to the applied voltage. In this case, the optical element 401 has a refractive index distribution with the shape of the lens 403, as shown in FIG. 3. Therefore, the optical element 401 has a refractive index distribution with the shape of a lens array in which a plurality of lenses 403 are arranged in a predetermined direction, as shown in FIG. 2.

Note that the refractive index distribution with the shape of the lens array, for example, is along the arrangement direction of the element pixels of the display element 402. More specifically, the optical element 401 has a refractive index distribution with the shape of the lens array in one or both of the horizontal and vertical directions on the display surface of the display element 402. Note that it is possible to adjust, based on the arrangement of the optical element 401 (that is, the shape and arrangement of the electrodes 401A and 401B), whether the optical element 401 has a refractive index distribution in one or both of the horizontal and vertical directions. Note that voltage conditions such as the strength of a voltage to be applied to the liquid crystal layer 401C and a voltage application time for attaining the specific alignment of the liquid crystal molecules 406 change depending on the type of liquid crystal molecules 406, the shape and arrangement of the electrodes 401A and 401B, and the like.

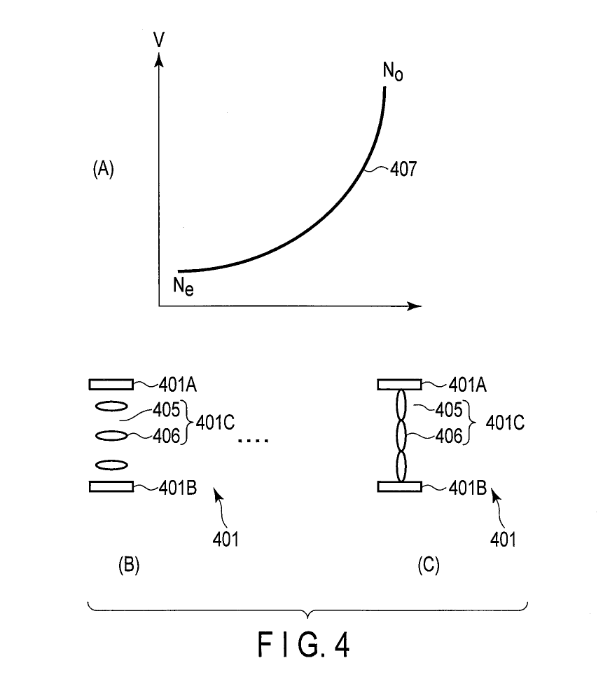

FIG. 4 is a view showing an example of a change in refractive index of the optical element 401 and the alignment state of the liquid crystal molecules 406. More specifically, (A) in FIG. 4 shows an example of the relationship between the refractive index of the optical element 401 and a voltage applied to the electrodes 401A and 401B. (B) and (C) in FIG. 4 show an example of the alignment state of the liquid crystal molecules 406 corresponding to the refractive index of the optical element 401.

In the example shown in FIG. 4, when no voltage is applied between the electrodes 401A and 401B, the liquid crystal molecules 406 are aligned in the horizontal direction (see (B) in FIG. 4), and a refractive index n has a small value ((A) in FIG. 4). Then, the liquid crystal molecules 406 are aligned in the vertical direction (see (C) in FIG. 4) when the voltage value to be applied to the electrodes 401A and 401B increases. The refractive index n of the optical element 401 increases with a change in alignment (see (A) in FIG. 4). In the example shown in FIG. 4, therefore, the relationship between the applied voltage and the refractive index of the optical element 401 is indicated by a curve 407.

When the arrangement of the electrodes 401A and 401B and conditions under which a voltage is applied to the liquid crystal layer 401C through the electrodes 401A and 401B are adjusted, the optical element 401 has a refractive index distribution with the shape of the lens 403, as shown in FIG. 3. Consequently, the optical element 401 has a refractive index distribution with the shape of the lens array, as shown in FIG. 2.

Although in this embodiment, a case in which the optical element 401 has the refractive index distribution with the shape of the lens 403 by applying the voltage is described, the present embodiment is not limited to this. The optical element 401 can be configured to have a refractive index distribution with a desired shape by, for example, adjusting conditions under which a voltage is applied to the electrodes 401A and 401B, and the arrangement and shape of the electrodes 401A and 401B. The voltage application conditions, and the arrangement and shape of the electrodes 401A and 401B may be adjusted so that, for example, the optical element 401 has a refractive index distribution with a prism shape. Furthermore, the voltage application conditions may be adjusted so that the optical element 401 has a refractive index distribution with both a prism shape and lens shape.

The display 400 according to this embodiment has the above-described arrangement. By controlling a voltage to be applied to the optical element 401, therefore, the lens shape of the optical element 401 changes, thereby enabling to change the optical characteristics such as the lens pitch and focal length of the optical element 401.

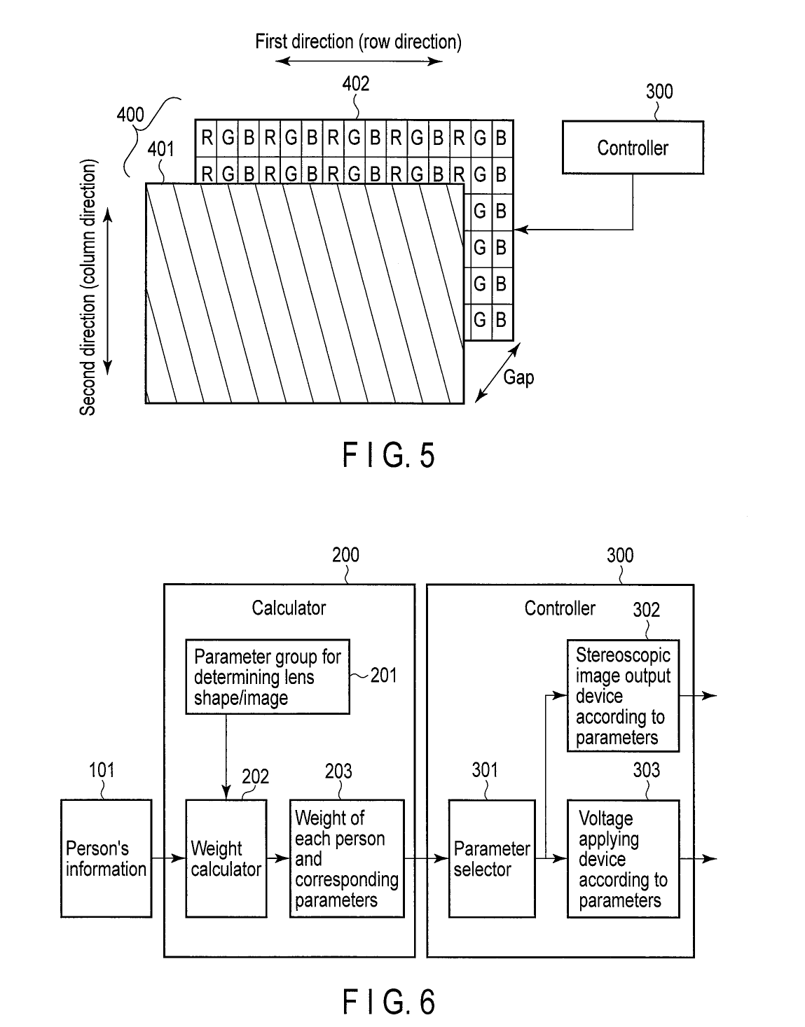

FIG. 5 is a view showing the display 400 when seen from the front side. The display 400 is a device capable of displaying a plurality of parallax images. The parallax images are used to cause the viewer to observe a stereoscopic image, and form the stereoscopic image. The stereoscopic image is obtained by assigning the pixels of the parallax images so that one of the eyes of the viewer P observes one parallax image and the other eye observes another parallax image when the viewer observes the display element 402 through the optical element 401 from the position of his/her viewpoint. That is, a stereoscopic image is generated by rearranging the pixels of each parallax image. Note that one pixel of a parallax image includes a plurality of sub-pixels. The display element 402 is a liquid crystal panel in which a plurality of sub-pixels each having a color component (for example, R, G, or B) are arranged in the first direction (row direction) and the second direction (column direction) in a matrix topology. Examples of the display element 402 are a direct-view two-dimensional display such as an organic EL (Electro Luminescence) display, LCD (Liquid Crystal Display), PDP (Plasma Display Panel), projection-type display, and plasma display. In the example of FIG. 5, one pixel includes sub-pixels having R, G, and B components. Sub-pixels respectively having R (red), G (green), and B (blue) components are repeatedly arranged in the order named in the first direction, and sub-pixels having the same color components are arranged in the second direction. The optical element 401 controls the direction in which a light ray exits from each sub-pixel of the display element 402. In the optical element 401, an optical aperture for passing light rays linearly extends, and a plurality of such optical apertures are arranged in the first direction. The display element 402 and optical element 401 have a given distance (gap) between them. Since the optical element 401 is arranged so that the extension direction of the optical aperture has a predetermined inclination with respect to the second direction (column direction) of the display element 402, the positions of the optical aperture and display pixel are different from each other in the row direction, and thus the viewing range (a region where it is possible to observe a stereoscopic image) changes depending on the height.

FIG. 6 shows the schematic arrangement of the calculator 200 and controller 300. The calculator 200 includes a weight calculator 202 which receives person's information 101 including the position of each person that has been acquired by the person's information acquirer 100, and a parameter group 201 for determining a lens shape/image, calculates a weight representing the quality of stereoscopic viewing for each person, and outputs the weight of each person and corresponding display parameters 203.

Assume that a weight W represents the quality of stereoscopic viewing. In this case, the weight W is calculated based on the person's information 101 for each display parameter of the display parameter group 201 associated with a multi-view image (that is, a combination of arrangements of pixels to be displayed) to be displayed on the stereoscopic image display device, and the hardware design and lens shape of the stereoscopic image display device. As the value of the weight W is larger, the stereoscopy is more satisfactory. The weight W reflects at least the position of each person but it can be arbitrarily changed. For example, the weight W may be changed to deal with several viewing modes selectable by the viewer. Note that targets controllable by the display parameters, such as a combination of arrangements of pixels to be displayed, will be described in detail later.

In this embodiment, a weight (to be referred to as a “position weight” hereinafter) according to the area of a stereoscopic enable display region, a light ray density, and a predetermined position is calculated. It is, therefore, necessary to be able to acquire position information of each person by some means. Furthermore, in this embodiment, an optical path length difference associated with crosstalk and the resolution of a stereoscopic image is calculated as another position weight. These position weights will be described in detail later.

Furthermore, in this embodiment, in addition to the position weight, a weight (to be referred to as an “attribute weight” hereinafter) according to the attributes of each person is calculated. The weight W is calculated by combining the value of the position weight and that of the attribute weight.

The controller 300 includes a parameter selector 301 which receives the weight W of each person and the corresponding display parameters 203 and selects display parameters with which the total of the weights of the respective persons that have been calculated by the calculator 200 becomes largest, an image output device 302 which outputs a stereoscopic image according to the display parameters selected by the parameter selector 301, and a voltage applying device 303 which outputs an applied voltage for changing the optical characteristics of the optical element 401 according to the display parameters selected by the parameter selector 301.

The more detailed arrangement of the stereoscopic image display device according to this embodiment will be described below.

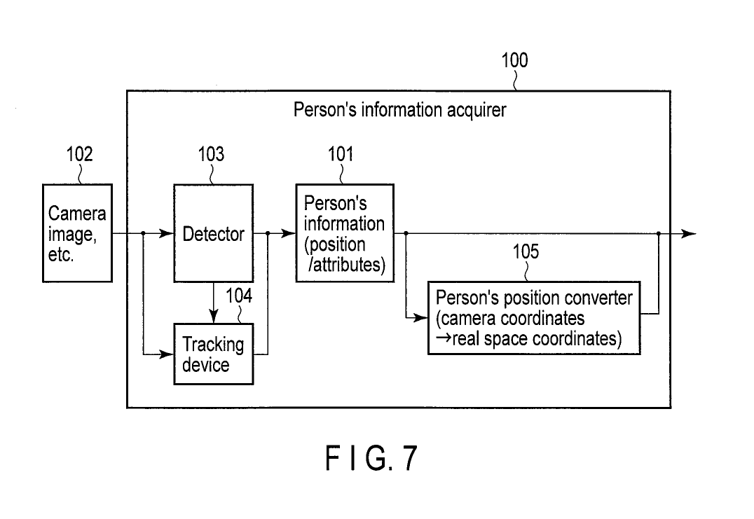

FIG. 7 shows the arrangement of the person's information acquirer 100. The person's information acquirer 100 includes a detector 103 which detects the position of each person by receiving a camera image or the like 102 and outputs the person's information 101 representing the position and attributes of each person, and a tracking device 104 which tracks a change in position of the same person, that is, movement of each person for a predetermined period of time based on the output of the detector 103.

The image used for position detection is not limited to an image from a camera and, for example, a signal provided by radar may be used. In the position detection operation, an arbitrary target such as a face, a head, a person as a whole, or a marker which can be determined as a human may be detected. Examples of the attributes of each person include information such as the name of each person, data for distinguishing between an adult and child, a viewing time, and data indicating whether the viewer is a remote controller holder. These pieces of information are detected by some means, or may be directly input by a viewer or the like.

Note that the person's information acquirer 100 may include a person's position converter 105 which converts a coordinate value in a camera coordinate system into that in a real space coordinate system with respect to the position information of each person output from the person's information acquirer 100. Furthermore, the person's position converter 105 may be provided in the calculator 200 instead of the person's information acquirer 100.

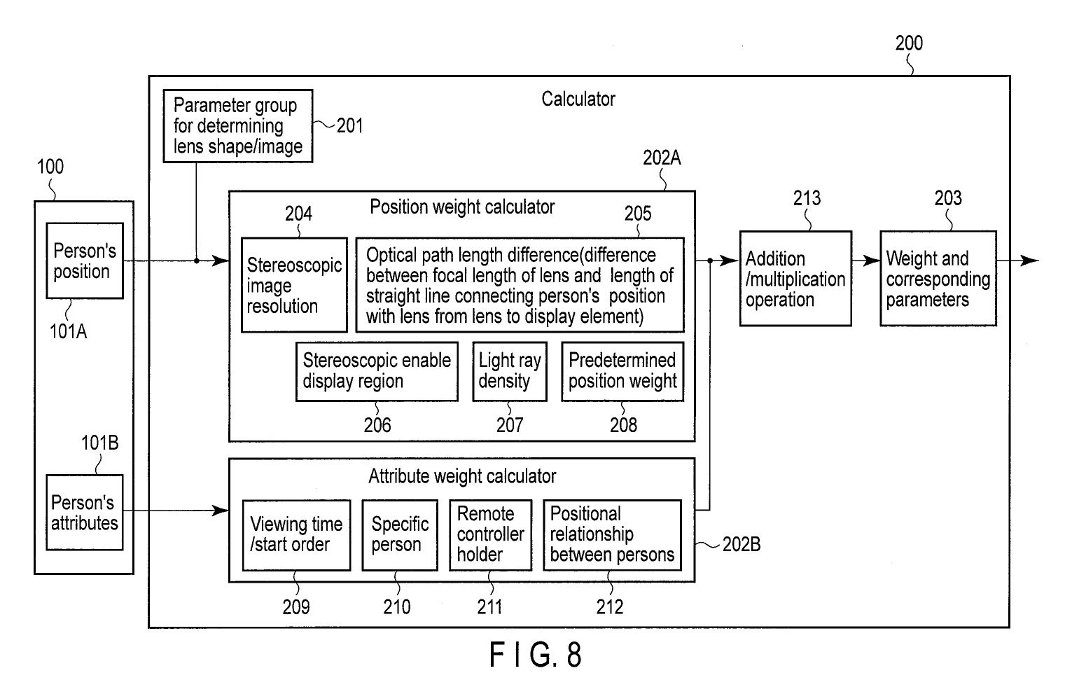

FIG. 8 shows the arrangement of the calculator 200. The calculator 200 includes a weight calculator 202 which receives the person's information 101 from the person's information acquirer 100 and the parameter group 201 for determining the lens shape/image, and calculates and outputs the weight of each person and the corresponding display parameters 203. The weight calculator 202 includes a position weight calculator 202A which calculates a position weight based on a person's position 101A and the parameter group 201, an attribute weight calculator 202B which calculates an attribute weight based on person's attributes 101B, and a calculator 213 which calculates a sum or product of the calculated position weight and attribute weight. Note that if one of the weights is used, an addition or multiplication operation can be omitted.

The position weight calculator 202A calculates a position weight based on a stereoscopic image resolution 204, an optical path length difference 205, a stereoscopic enable display region 206, a light ray density 207, a predetermined position weight 208, or the like. The stereoscopic image resolution 204 is a weight associated with a resolution depending on a change in lens pitch of the optical element 401. The optical path length difference 205 is a weight associated with a crosstalk amount depending on a change in focal length. More specifically, the optical path length difference 205 corresponds to a difference (|f−dm|) between a lens focal length f of the optical element 401 and a length dm of a straight line connecting a person's position with the lens position of the optical element 401 from the lens position to the display element 402. The weights based on the stereoscopic image resolution 204 and optical path length difference 205 will be described in detail later.

The area of the stereoscopic enable display region 206 is determined based on the position of each person (that is, the relative position with respect to the display screen of the stereoscopic image display device) and a multi-view image. As the area is larger, the value of the position weight is larger. The light ray density 207 is determined based on the number of viewpoints and the distance from the display screen of the stereoscopic image display device. As the light ray density 207 is higher, the position weight is larger. As for the predetermined position weight 208, a position where the viewer normally views an image is assigned with a weight larger than those for other positions.

The position weight calculator 202A calculates and outputs a sum or product of the weight values which have been respectively calculated for the stereoscopic image resolution 204, optical path length difference 205, stereoscopic enable display region 206, light ray density 207, predetermined position weight 208, and the like. Note that if one of the weights is used, calculation of a sum or product of the position weights can be omitted. In addition to them, a term which can represent a weight associated with the appearance may be added.

The attribute weight calculator 202B calculates an attribute weight based on an attribute value such as a viewing time or start order 209, a specific person 210, a remote controller holder 211, or a positional relationship between persons 212. As for the viewing time or start order 209, a person who is viewing for a long time or a person who has started viewing earlier is assigned with a larger weight value to have high priority. Similarly, the specific person 210 or remote controller holder 211 is assigned with a larger weight value to have high priority. As for the positional relationship between persons 212, a person, among all viewers, who is in front of the display or is closer to the display, is assigned with a larger weight value. The attribute weight calculator 202B calculates and outputs a sum or product of the weight values which have been respectively calculated for the viewing time or start order 209, the specific person 210, the remote controller holder 211, the positional relationship between persons 212, and the like. Note that if one of the weights is used, an addition or multiplication operation can be omitted. In addition to them, a term which can represent a weight associated with the attributes of a viewer may be added.

Furthermore, the calculator 213 calculates a sum or product of the value of the position weight output from the position weight calculator 202A and the value of the attribute weight output from the attribute weight calculator 202B.

Note that it is necessary to at least calculate a position weight except when parameters are selected based on only the information of the specific person 210. The weight of each person is calculated for each of a plurality of display parameters included in the parameter group 201 for determining the lens shape/image. Furthermore, a weight is calculated for all the persons in principle (except when parameters are selected based on only the information of the specific person 210).

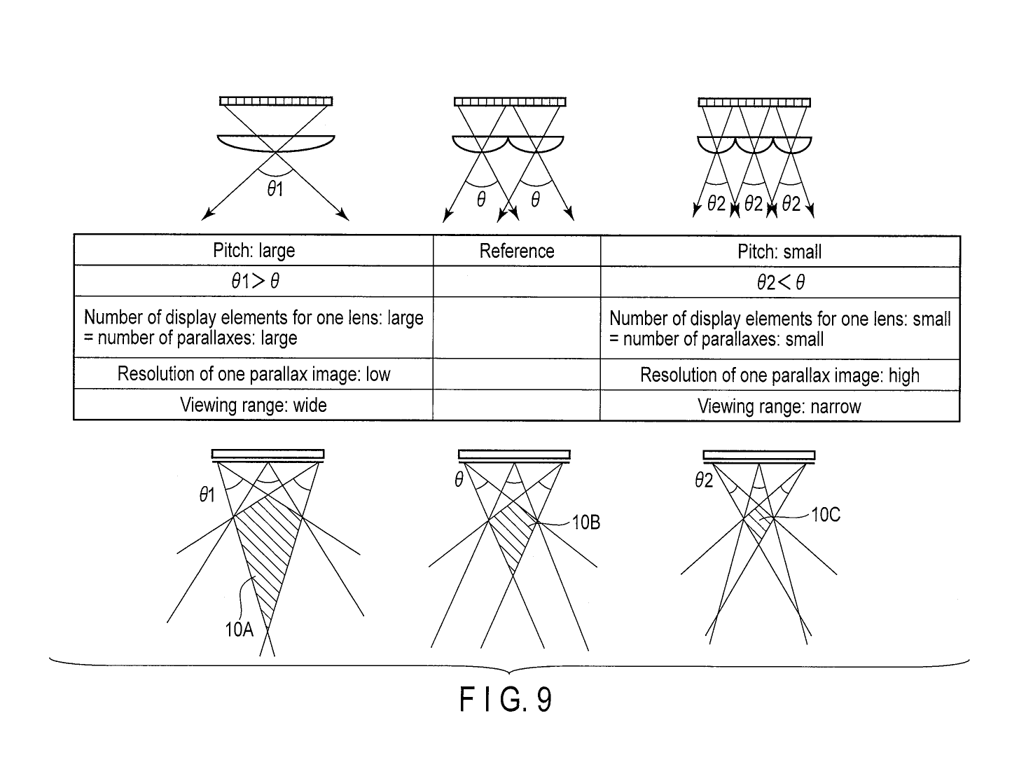

The weight based on the stereoscopic image resolution 204 will be described with reference to FIG. 9.

When the lens pitch of the optical element 401 changes with respect to a reference, the number of parallaxes, the resolution of one parallax image, and the viewing range change. When the lens pitch of the optical element 401 changes to be larger than the reference (θ1>θ), the number of display elements for one lens increases. At this time, if the number of display pixels for one parallax image for one lens is constant, the number of parallaxes increases. The resolution of one parallax image can be represented by H×V/N where H represents the number of pixels in the horizontal direction, V represents the number of pixels in the vertical direction, and N represents the number of parallaxes. The resolution indicates the number of pixels for one parallax, which corresponds to the stereoscopic image resolution 204. If the lens pitch of the optical element 401 becomes larger than the reference, the number of parallaxes increases as described above, thereby decreasing the resolution of one parallax image. As is apparent from FIG. 9, the viewing range expands from a region 10B to a region 10A. On the other hand, if the lens pitch of the optical element 401 becomes smaller than the reference (θ2<θ), the number of display elements for one lens decreases, thereby reducing the number of parallaxes. The resolution of one parallax image, therefore, increases. As is apparent from FIG. 9, the viewing range reduces from the region 10B to a region 10C.

As for such the variable stereoscopic image resolution 204, for example, a larger weight is assigned as the stereoscopic image resolution 204 is higher (that is, the number of parallaxes is smaller and the lens pitch is smaller). To the contrary, a smaller weight is assigned as the stereoscopic image resolution 204 is lower (that is, the number of parallaxes is larger and the lens pitch is larger). More specifically, a weight may be calculated according to equation (1), (2), or (3).

(1) Use of Resolution R of One Parallax Image

Let Rₘₐₓ be the resolution of a panel. Then, a weight w₁ when the resolution of one parallax image is R is calculated according to:

w₁=R/Rₘₐₓ (1)

This equation gives a larger weight value as the resolution R for one parallax is higher. As long as the equation is satisfied, any method other than equation (1) may be used.

(2) Use of Number N of Parallaxes

Let Nₘₐₓ be the maximum number of parallaxes. Then, a weight w₁ for the number N of parallaxes is calculated according to:

w₁=1−N/Nₘₐₓ (2)

This equation gives a larger weight value as the number N of parallaxes is smaller. As long as the equation is satisfied, any method other than equation (2) may be used.

(3) Use of Lens Pitch p

Let pₘₐₓ be the maximum lens pitch. Then, a weight w₁ for the lens pitch p is calculated according to:

w₁=1−p/pₘₐₓ (3)

This equation gives a larger weight value as the lens pitch p is smaller. As long as the equation is satisfied, any method other than equation (3) may be used.

In equation (1), (2), or (3), the fraction portion is an important term. The weight is obtained by comparing each parameter with a maximum possible value of the parameter. Note that a Gaussian distribution with a fraction as an argument may be used. Instead, a sigmoid function with the resolution R, the number N of parallaxes, and the lens pitch p as arguments may be used.

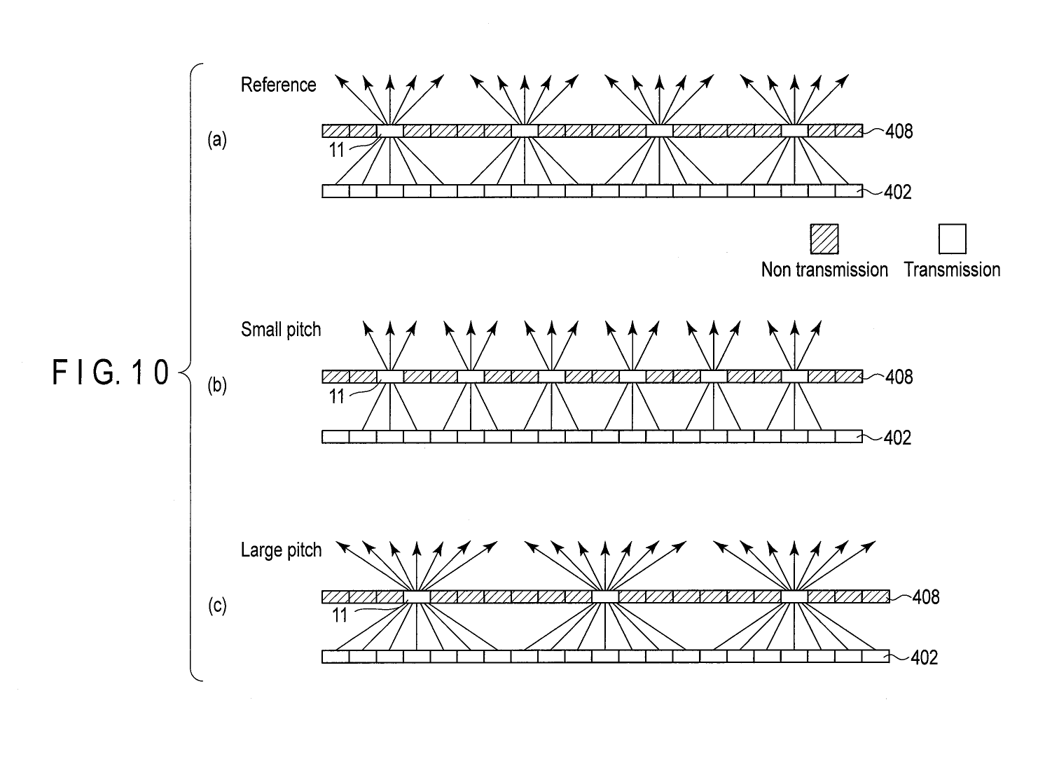

FIG. 10 is a view showing a case in which a liquid crystal barrier is applied as an optical element. A liquid crystal barrier can be used as the optical element 401 instead of an element (birefringent element) with a variable refractive index distribution. As shown in FIG. 10, it is possible to use a liquid crystal barrier 408 to change the pitch of an optical aperture (corresponding to a lens) 11 which transmits light, as shown in (a) to (c) of FIG. 10.

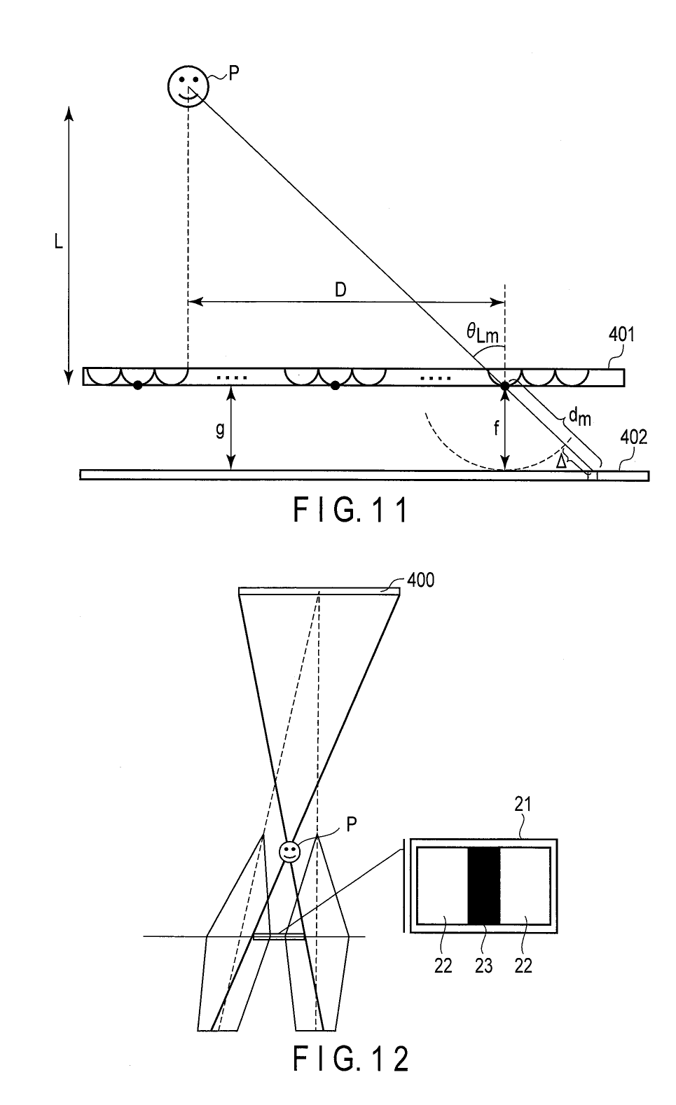

FIG. 11 is a view for explaining the weight based on the optical path length difference. As described above, it is possible to change the focal length of the optical element 401. When the focal length is changed, an in-focus direction and an in-focus distance change. Consequently, the crosstalk amount, that is, the degree of satisfaction of the “appearance” of a stereoscopic image, changes. As the crosstalk amount is smaller, the “appearance” of the stereoscopic image is more satisfactory. It is difficult to calculate the crosstalk amount itself. Let dm be the optical path length of a line segment connecting the position of the viewer P with the principal point of the lens from the principal point of the lens to a display pixel, and Δ be the difference between the focal length f of the lens and the optical path length dm. When Δ is close to 0, the focal point of the lens exists at the position of the display pixel, the light reaches the position of the viewer P most effectively, and thus the crosstalk amount reduces. To the contrary, when Δ has a value away from 0, the focal point exists behind (or in front of) the display pixel, light around the display pixel also reaches the position of the viewer P, and thus the crosstalk amount increases. A weight, therefore, is calculated according to the value of Δ using the optical path length difference Δ=|f−dm| as an amount reflecting crosstalk, as indicated by:

$$Δ = \vert f - {d}_{m} \vert$$

$${d}_{m} = \frac{g}{sin {θ}_{Lm}}$$

$${θ}_{Lm} = arc cos \frac{L}{\sqrt{{L}^{2} + {D}^{2}}}$$

As the optical path length difference Δ is smaller, a weight for the “appearance” of the stereoscopic image is set to be larger. To the contrary, as the optical path length difference Δ is larger, a weight for the “appearance” of the stereoscopic image is set to be smaller.

The optical path length difference Δ is preferably calculated for each lens. For example, Δ may represent a weighted average for an optical path length difference Δi of a lens i. The weight in this case may be constant, or may be changed to have a smaller value toward the edge of the screen. It is possible to use the thus calculated optical path length difference Δ to calculate a weight w₂ associated with the “appearance” of the stereoscopic image, according to:

w₂=exp(Δ/σ²)

where the weight w₂ conforms to the Gaussian distribution.

Alternatively, let Δₘₐₓ be the maximum value of the optical path length difference Δ. Then, the weight w₂ can be calculated according to:

w₂=1−Δ/Δₘₐₓ

where Δ is 0 or larger.

Calculation of the weight based on the area of the stereoscopic enable display region 206 will be described next with reference to FIG. 12. The view of the “appearance” can be geometrically obtained, and calculated. A pattern 21 clipped by lines respectively connecting the viewer P with both sides of the display 400 at a viewing range setting distance coincides with the “appearance” of the display. In the example of FIG. 12, a region 22 in the pattern 21 is a stereoscopic enable region and a region 23 is a stereoscopic disable region. It is possible to calculate, as a weight, the ratio of the stereoscopic enable region 22 to the area of the whole region of the pattern 21. If, for example, the ratio of the stereoscopic enable region 22 is 100%, stereoscopy is possible in the whole region, and a value “1” is set as a maximum value.

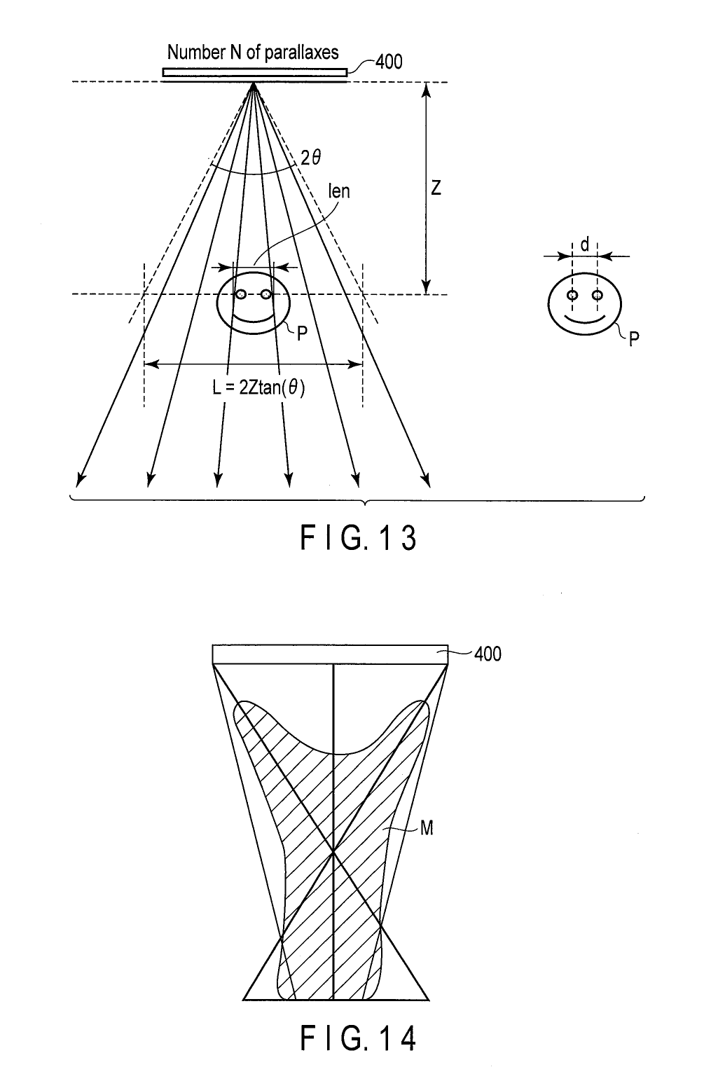

Calculation of the weight based on the light ray density 207 will be described next with reference to FIG. 13. Let N be the number of parallaxes, 2θ be the divergence angle of light rays, Z be the distance from the display 400 to the viewer P, and d be the difference between the eyes of the viewer P. Then, it is possible to calculate the weight based on the light ray density 207 according to:

$$L = 2 Z tan ( θ )$$

$${w}_{ray} ( z ) = \{ \begin{matrix}1 & if z < \frac{dN}{2 tan ( θ )} \\ \frac{d}{L / N} & othewise\end{matrix}$$

That is, assume that the ratio between the width len of light rays at the position of the eyes of the viewer P and the distance d between the eyes is the weight based on the light ray density 207. If the width len of the light rays is smaller than the distance d between the eyes, the value of the weight based on the light ray density 207 is set to “1”.

FIG. 14 shows an example of a map M obtained by arranging the weight values calculated by the calculator 200 in the real space coordinate system.

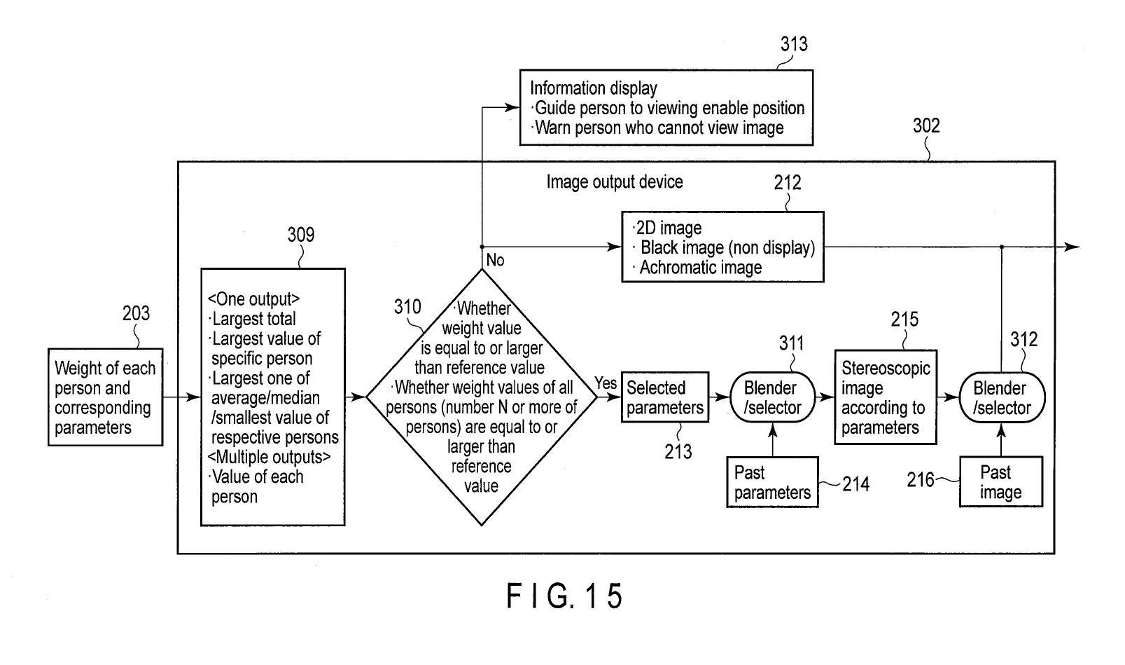

FIG. 15 shows the arrangement of the image output device. The image output device 302 receives the weight of each person and the corresponding display parameters 203 which have been input from the calculator 200. As the weight of each person and the corresponding display parameters 203, one or multiple outputs may be provided. For example, if one output is provided, a largest total of the weights of the respective persons, a largest weight of a specific person, or a larger value of the average and median of the weights of the respective persons may be used. Alternatively, priority levels are assigned to viewers according to attribute weights, and then a largest total of the weights of respective persons with a given priority level or higher, or a larger value of the average and median of the weights may be used. If multiple outputs are provided, a largest value of the weight values of the respective persons may be used.

A determiner 310 of the image output device 302 determines whether the weight value as described above is equal to or larger than a predetermined reference value. If multiple outputs are provided, it is determined whether the weight values of all the persons (or the number N or more of persons) are equal to or larger than the predetermined reference value. Alternatively, priority levels may be assigned to viewers according to attribute weights, and then the determination may be made for only persons with a given priority level or higher. In either case, the display parameters 203 corresponding to the weight equal to or larger than the reference value are selected. The image output device 302 may include a blender/selector 311 for blending past display parameters 214 with the selected display parameters to slowly change the image based on the past display parameters 214, or changing a scene so that the change is difficult to perceive or switching the image when the image frequently moves, as processing for improving the visibility in image switching. Similarly, the image output device 302 may also include a blender/selector 312 for, for example, blending a past image 216 with a multi-view image (stereoscopic image) 215 according to the display parameters output from the blender/selector 311 to slowly change the image based on the past image 216. The blend processing preferably absorbs a first-order delay and the like.

Note that it is also possible to obtain a multi-view image (stereoscopic image) according to the selected display parameters by physically changing the position and orientation of the display 400, as will be described later.

If the determiner 310 determines that the weight value is smaller than the reference value, a two-dimensional image, a black image (non-display), or an achromatic image 212 is displayed (2D display) to prevent inappropriate stereoscopy. A criterion for performing 2D display is, for example, that the total of the weights is small, there is a person who cannot view an image, or display is dependent on the viewing experience of a specific person. In this case, the image output device 302 may further include an information display 313 which guides a person to a position where stereoscopy is available, or warns that stereoscopy is available.

As for the parameter group 201 for determining an image, an example of a control operation using the respective display parameters will now be described. The display parameters include parameters to be controlled for a viewing range and those to be controlled for a light ray density. The display parameters to be controlled for the viewing range include the shift of an image, the pitch between pixels, the gap between a lens and a pixel, and rotation, deformation, or movement of a display. The display parameters to be controlled for the light ray density include the gap between a lens and a pixel, and the number of parallaxes.

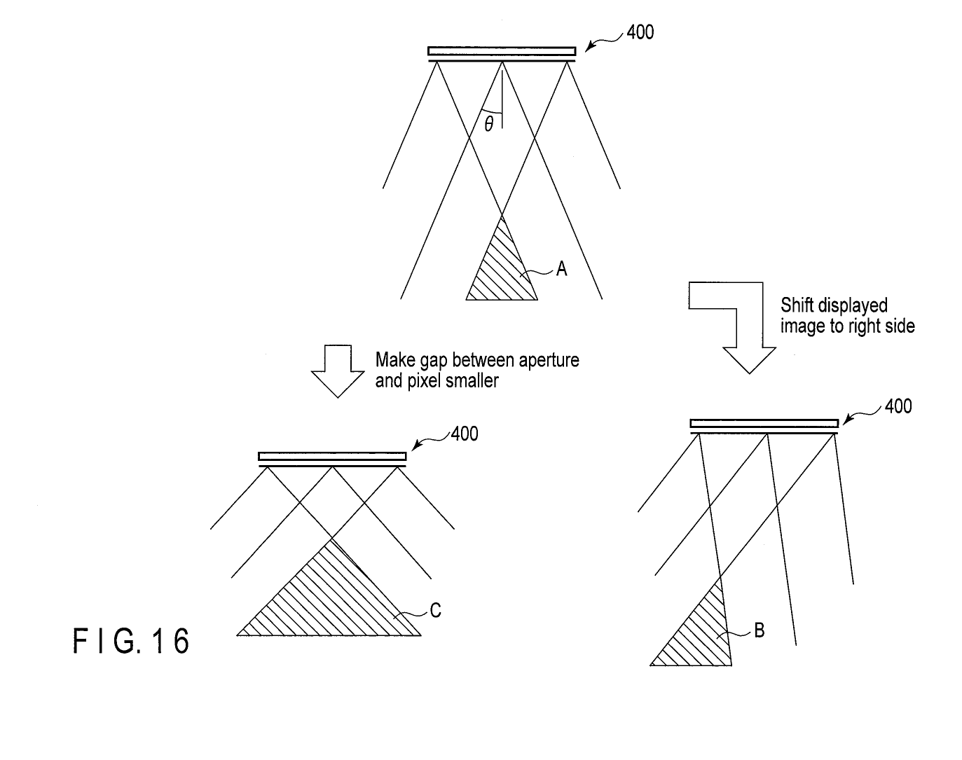

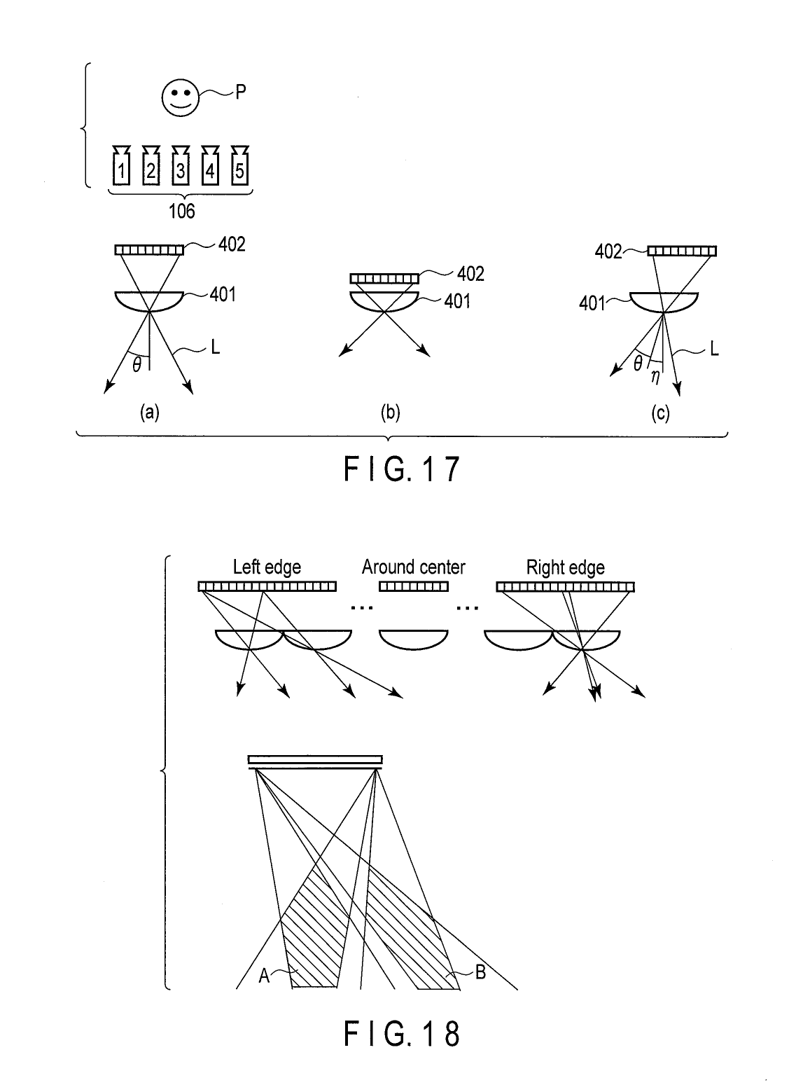

The display parameters to be controlled for the viewing range will be described with reference to FIGS. 16 and 17. If, for example, a displayed image is shifted to the right side, a region where satisfactory stereoscopy is possible, that is, the “viewing range” changes from a viewing range A to a viewing range B, as shown in FIG. 16. This is because a light ray L moves to the left side in (c) of FIG. 17, and thus the viewing range also moves to the left side to obtain the viewing range B, as is apparent by comparing (a) with (c) in FIG. 17.

As is apparent by comparing (a) with (b) in FIG. 17, if the gap between the optical element 401 and the display element 402 is made smaller, the viewing range A changes to a viewing range C as shown in FIG. 16. In this case, although the viewing range becomes closer, the light ray density reduces.

Note that as shown in FIG. 17, parallax images are sequentially arranged in the display element 402. The parallax images indicate images viewed from different viewpoints and, for example, correspond to images obtained by shooting the viewer P by a plurality of cameras 106, as shown in FIG. 17. A light ray from the display element 402 (sub-pixel) exits through the lens (optical aperture) 401. It is possible to geometrically obtain the shape of the viewing range using θ and η shown in FIG. 17.

A neighboring viewing range will be described with reference to FIG. 18. A viewing range B next to a viewing range A where the viewer mainly views an image is formed by a combination of (the left-most pixel, a lens on the right side of the left-most lens) and (a pixel on the left side of the right-most pixel, the right-most lens). It is also possible to further move the viewing range B to the left or right side.

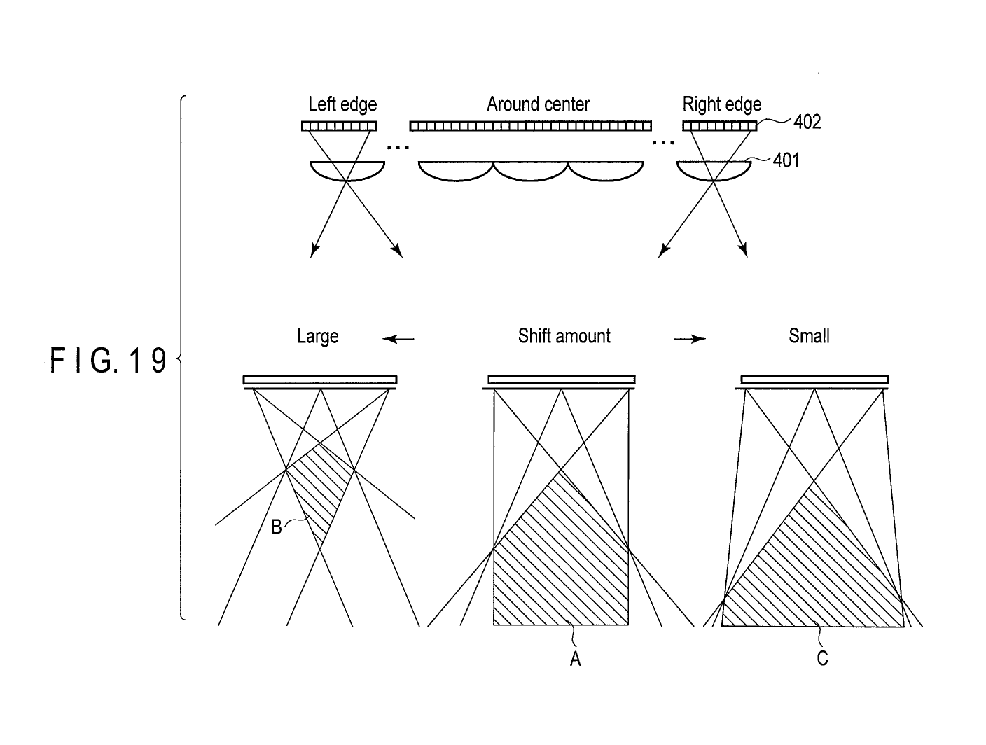

A control operation according to the arrangement (display pitch) of pixels to be displayed will be described with reference to FIG. 19. It is possible to control the viewing range by shifting the positions of the display element 402 and optical element (lens) 401 from each other by a relatively larger amount toward the edge (right or left edge) of the screen. If the shift amount of the relative positions of the display element 402 and optical element 401 becomes larger, the viewing range changes from a viewing range A to a viewing range B, as shown in FIG. 19. To the contrary, if the shift amount of the relative positions of the display element 402 and optical element 401 becomes smaller, the viewing range changes from the viewing range A to a viewing range C, as shown in FIG. 19. As described above, it is possible to control the width or closeness of the viewing range with the display parameters associated with the arrangement (pixel pitch) of the pixels. Note that a location with a largest width of the viewing range will be referred to as a “viewing range setting distance”.

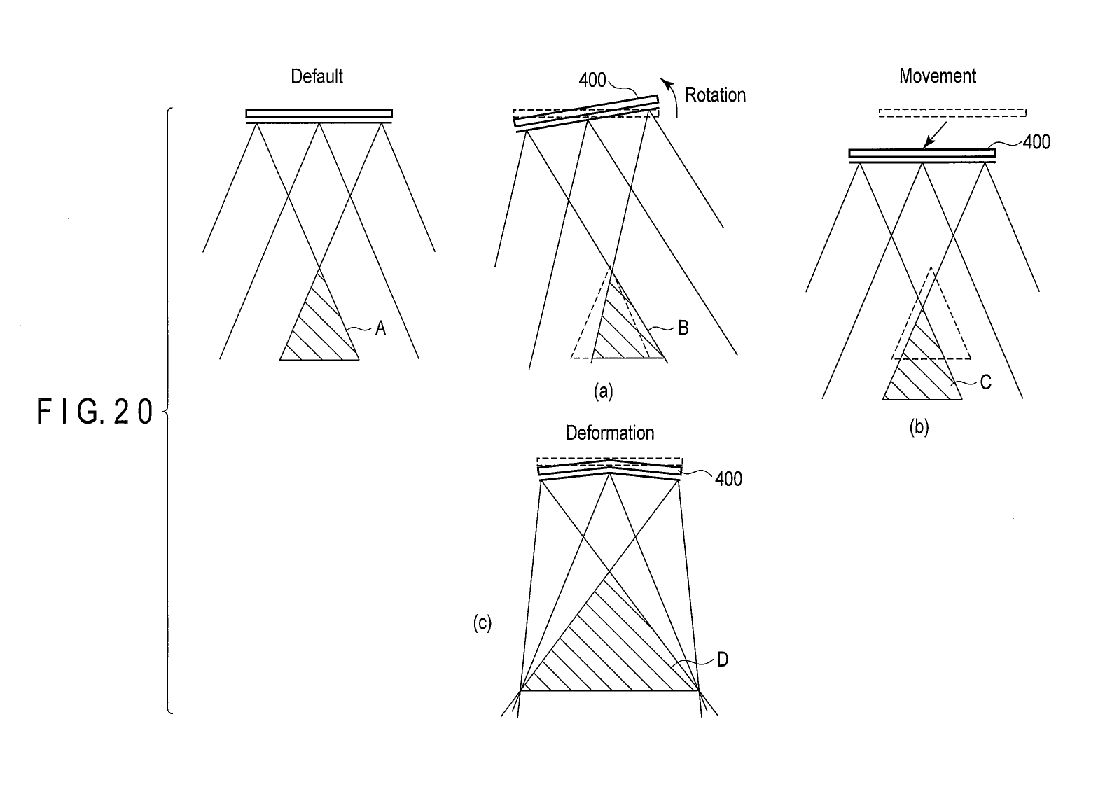

An operation of controlling a viewing range by moving, rotating, or deforming the display 400 will be described with reference to FIG. 20. As shown in (a) of FIG. 20, it is possible to change a default viewing range A to a viewing range B by rotating the display 400. Similarly, it is possible to change the default viewing range A to a viewing range C by moving the display 400, or to change the default viewing range A to a viewing range D by deforming the display 400. Thus, the viewing range can be controlled by changing the display parameters to move, rotate, or deform the display 400.

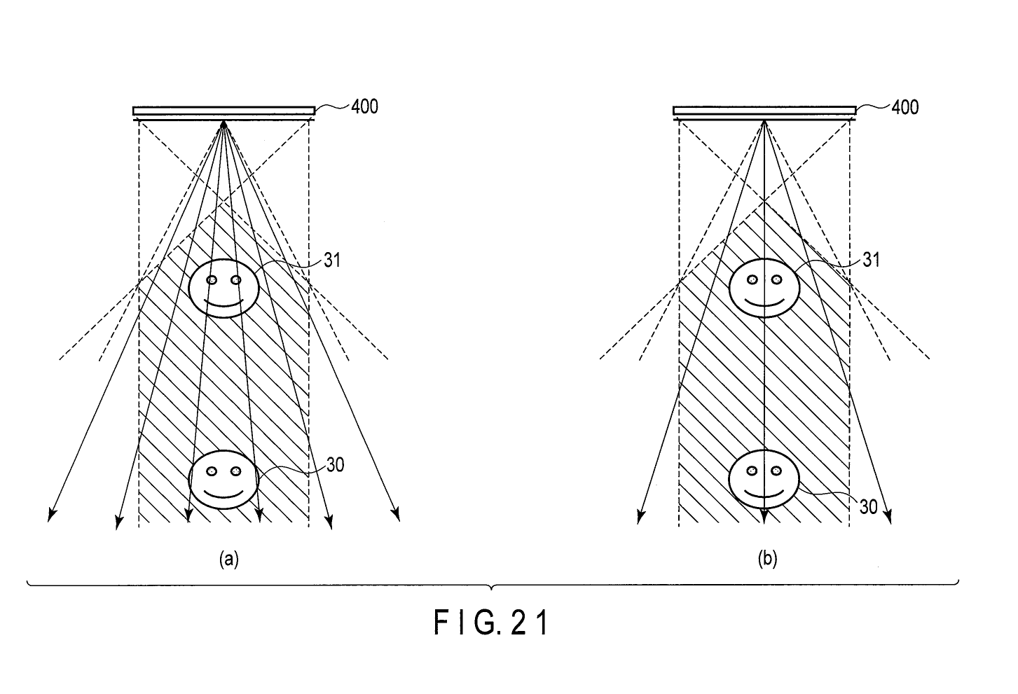

As for the display parameters to be controlled for a light ray density, light densities when the numbers of parallaxes are different will be described with reference to FIG. 21.

If, for example, the number of parallaxes shown in (a) of FIG. 21 is 6, the number of light rays for giving parallaxes is larger for a person 31 who is relatively closer to the display 400 than a person 30, thereby making stereoscopy satisfactory for him or her. If the number of parallaxes shown in (b) of FIG. 21 is 3, it is smaller than the number of parallaxes shown in (a) of FIG. 21 and the light rays are less dense, thereby making stereoscopy at the same distance difficult. It is possible to calculate the light ray density of light rays coming from the respective pixels of the display 400 based on an angle θ determined based on a lens and gap, the number of parallaxes, and the position of a person.

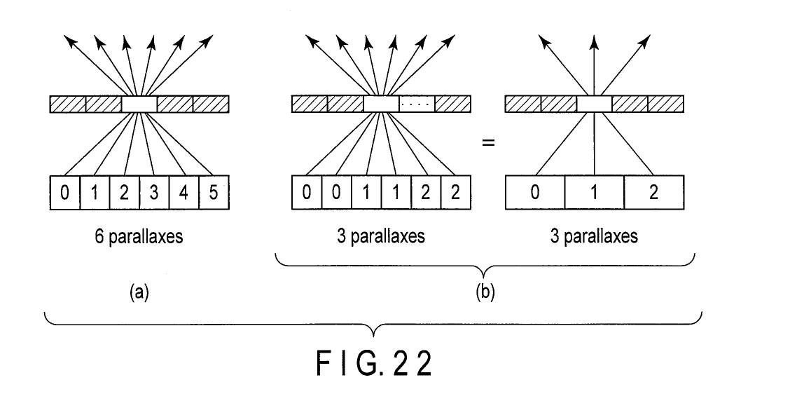

A case in which the number of parallaxes is switched in a software manner will be described. In the above-described embodiment, a case in which when changing the lens pitch of the optical element 401, the number of parallaxes changes, and accordingly, the resolution of the stereoscopic image also changes has been described. The resolution can be switched not only by changing the lens pitch of the optical element 401 but also by switching the number of parallaxes in a software manner. For example, (a) of FIG. 22 shows six parallaxes, that is, a case in which the number of parallaxes is “6”. By connecting two neighboring pixels, it is possible to change to three parallaxes, that is, to change the number of parallaxes to “3”, as shown in (b) of FIG. 22. When switching the number of parallaxes in a software manner, a weight may be calculated similarly to a case in which the lens pitch of the optical element 401 is changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The acquirer 100, the calculator 200, and the controller 300 in this embodiment may be distributed by storing as a program allowing the computer to execute in a recording medium such as a magnetic disk (flexible disk, hard disk etc.), an optical disk (CD-ROM, DVD etc.) or a semiconductor memory and so on.

What is claimed is:

1. A stereoscopic image display device comprising:
a display element in which a plurality of pixels are arranged in a matrix topology;
an optical element coupled to the display element, the optical element having variable optical characteristics;
an acquirer configured to acquire person's information including a position of each of at least one person viewing a stereoscopic image;
a calculator configured to calculate, based on the person's information, a weight representing a quality of stereoscopic viewing for each person; and
a controller configured to select optical characteristic parameters corresponding to the weight, and control the optical characteristics of the optical element based on the optical characteristic parameters.

2. The device according to claim 1, wherein the controller selects optical characteristic parameters with which a total of the weights of the respective persons becomes largest.

3. The device according to claim 1, wherein the calculator calculates the weight based on a resolution of one parallax image in addition to the person's information.

4. The device according to claim 1, wherein the calculator calculates the weight based on the number of parallaxes in addition to the person's information.

5. The device according to claim 1, wherein the calculator calculates the weight based on a lens pitch of the optical element in addition to the person's information.

6. The device according to claim 1, wherein the optical element is an optical element with a variable refractive index distribution.

7. The device according to claim 6, wherein the optical characteristic parameters include parameters for changing the refractive index distribution.

8. The device according to claim 1, wherein the optical element is an optical element in which a pitch of an optical aperture is variable.

9. The device according to claim 8, wherein the optical characteristic parameters include parameters for changing the pitch of the aperture of the optical element.

10. The device according to claim 1, wherein the calculator calculates the weight based on a difference between a second optical path length corresponding to a focal length of the optical element and a first optical path length from the principal point of each lens of the optical element to a pixel existing on an optical path which connects the position of each person with the principal point, in addition to the person's information.

11. The device according to claim 10, wherein as the difference between the first optical path length and the second optical path length is smaller, the weight is set to be larger.

12. The device according to claim 1, wherein the controller selects, based on the weight of each person calculated by the calculator, parameters for changing the number of parallaxes by changing an arrangement of pixels to be displayed, and outputs a multi-view image according to the selected parameters.

13. A stereoscopic image display method for a stereoscopic image display device including a display element in which a plurality of pixels are arranged in a matrix topology, and an optical element coupled to the display element, the optical element having variable optical characteristics, the method comprising:
acquiring person's information including a position of each of at least one person viewing a stereoscopic image;
calculating, based on the person's information, a weight representing a quality of stereoscopic viewing for each person; and
selecting optical characteristic parameters corresponding to the weight, and controlling the optical characteristics of the optical element based on the optical characteristic parameters.

14. A control device for controlling a stereoscopic image display device including a display element in which a plurality of pixels are arranged in a matrix topology, and an optical element coupled to the display element, the optical element having variable optical characteristics, comprising:
an acquirer configured to acquire person's information including a position of each of at least one person viewing a stereoscopic image;
a calculator configured to calculate, based on the person's information, a weight representing a quality of stereoscopic viewing for each person; and
a controller configured to select optical characteristic parameters corresponding to the weight, and control the optical characteristics of the optical element based on the optical characteristic parameters.
